(19) United States
(12) Patent Application Publication
(10) Pub. No.: US 2015/0168126 A1
(43) Pub. Date: Jun. 18, 2015

(54) SYSTEM AND METHOD FOR OPTICAL COHERENCE TOMOGRAPHY

(71) Applicant: Technion Research & Development Foundation Limited, Haifa (IL)

(72) Inventors: Amir Nevet, Haifa (IL); Tomer Michael, Zikhron-Yaakov (IL); Meir Orenstein, Haifa (IL)

(73) Assignee: Technion Research & Development Foundation Limited, Haifa (IL)

(21) Appl. No.: 14/399,188

(22) PCT Filed: May 6, 2013
(86) PCT No.: PCT/IL2013/050383

§ 371 Date: Nov. 6, 2014

Related U.S. Application Data
(60) Provisional application No. 61/644,533, filed on May 9, 2012.

(51) Int. Cl. G01B 9/02; G01B 11/00

(52) U.S. Cl. CPC G01B 9/02091; G01B 11/00

(57) ABSTRACT

A system for optical coherence tomography (OCT) is disclosed. The system comprises an optical interferometer apparatus configured to split an optical beam into a reference beam directed to a reference reflector and a sample beam directed to a sample, and to combine a reflected beam from the reference reflector with a returning beam from the sample to form a combined optical signal. The system further comprises a two photon detector configured to detect the combined optical signal by two photon absorption and to provide a corresponding electrical signal, a frequency separation system configured to separate a low frequency component from the electrical signal, and a data processor configured for providing a topographic reconstruction of the sample based, at least in part, on the low frequency component.

### FIELD AND BACKGROUND OF THE INVENTION

The present invention, in some embodiments thereof, relates to optics and, more particularly, but not exclusively, to a system and method for optical coherence tomography.

Optical Coherence Tomography (OCT) is an imaging technique, providing a micron-scale resolution of scattering media to a depth of a few millimeters via a nondestructive, contact-free measurement. OCT is particularly useful in the field of medical imaging since it can provide non-invasive diagnostic images. Generally, OCT extract imagery information from an optical signal resulted from a coherent interference between a reference light beam and a light beam reflected from a sample.

Time domain OCT is a technique in which light beam coming from a broadband light source is split by an optical splitter into two light beams, which are incident on, and then reflected from, a reference mirror and a sample to be imaged. The reflected light beams are combined at the optical splitter, and the optical path length difference between the two light beams gives rise to an interference signal, which is detected and processed. Lateral scan is obtained by scanning the beam over the sample, and depth scan is obtained by moving the reference mirror with respect to the optical splitter. For each position of the reference mirror, a cycle of lateral scan allows reconstructing a two-dimensional cross section of the sample. A three-dimensional image can then be reconstructed from all the cross sections.

Frequency domain OCT is a technique in which the optical setup is altered by either detecting the output optical signal through a spectrometer or by scanning the source through a wide range of wavelengths. This technique is based on a Fourier relation between the light spectrum and its autocorrelation, enabling the extraction of depth information via digital post-processing without actually moving the reference mirror.

Polarization sensitive OCT (PS-OCT) is a technique which gives functional information regarding the biochemical composition where highly organized tissues are present [de Boer and Milner, “Review of polarization sensitive optical coherence tomography and Stokes vector determination,” J. Biomed. Opt. 7(3), 359-371 (2002)].

Quantum OCT (QOCT) is a technique which is based on the Hong-Ou-Mandel effect [Nasr et al., “Demonstration of Dispersion-Canceled Quantum-Optical Coherence Tomography,” Phys. Rev. Lett. 91, 083601 (2003)]. This technique employs quantum interference hence results in dispersion cancellation and improved resolution. Also known are classical analogies of QOCT using chirped-pulse interferometry [Lavoie et al., “Quantum-optical coherence tomography with classical light,” Opt. Express 17, 3818-3825 (2009)], or phasematched sum-frequency generation [Pe'er et al., “Broadband sum-frequency generation as an efficient two-photon detector for optical tomography,” Opt. Express 15, 8760-8769 (2007)].

Additional background art includes Lajunen et al., “Resolution-enhanced optical coherence tomography based on classical intensity interferometry,” J. Opt. Soc. Am. A, 26:4, 1049 (2009), and Zerom et al., “Optical Coherence Tomography based on Intensity Correlations of Quasi-Thermal Light,” Conference on Lasers and Electro-Optics, 2009.

### SUMMARY OF THE INVENTION

According to an aspect of some embodiments of the present invention there is provided a system for optical coherence tomography (OCT). The system comprises: an optical interferometer apparatus configured to split an optical beam into a reference beam directed to a reference reflector and a sample beam directed to a sample, and to combine a reflected beam from the reference reflector with a returning beam from the sample to form a combined optical signal. The system further comprises a two photon detector configured to detect the combined optical signal by two photon absorption and to provide a corresponding electrical signal, and a frequency separation system configured to separate a low frequency component from the electrical signal. The system further comprises a data processor configured for providing a topographic reconstruction of the sample based, at least in part, on the low frequency component.

According to some embodiments of the invention the invention the frequency separation system comprises an optical element positioned at the optical path of the combined optical signal, wherein the detector engages an image plane of the optical element.

According to some embodiments of the invention the system comprises a digitizer for digitizing the electrical signal, wherein the frequency separation system comprises a digital low pass filter.

According to some embodiments of the invention the frequency separation system comprises an analog low pass filter.

According to some embodiments of the invention the data processor is configured to analyze a carrier frequency component of the electrical signal, to compare the carrier frequency component with the low frequency component, and to generate an output pertaining to at least one property of the sample other than the topographic reconstruction.

According to some embodiments of the invention the at least one property comprises isotropy or deviation from isotropy.

According to some embodiments of the invention the frequency separation system comprises an optical device positioned in an optical path of the reflected beam and configured for modulating the reflected beam.

According to some embodiments of the invention the optical device comprises a high frequency modulator.

According to some embodiments of the invention the optical device comprises a phase modulator.

According to some embodiments of the invention the reference reflector is mounted on a translation stage characterized by a spatial resolution of at least 20 nm.

According to some embodiments of the invention the reference reflector is mounted on a translation stage characterized by a spatial resolution of at least 2 μm.

According to some embodiments of the invention the reference reflector comprises an array of reflectors configured to provide a plurality of spatially separated reflected beams.

According to some embodiments of the invention the system comprises: at least one optical modulator configured to modulate at least one of the reflected beam and the returning beam, and a controller for controlling the modulation, wherein the data processor is configured to identify noise component in the electrical signal based on the controlled modulation.

According to some embodiments of the invention the data processor is configured to employ time domain topographic reconstruction.

According to some embodiments of the invention the data processor is configured to employ frequency domain topographic reconstruction.

According to some embodiments of the invention the optical interferometer apparatus comprises a non-linear optical medium configured and positioned to combine the reflected beam and the returning beam.

According to an aspect of some embodiments of the present invention there is provided a method of optical coherence tomography (OCT). The method comprises: to splitting an optical beam into a reference beam directed to a reference reflector and a sample beam directed to a sample and combining a reflected beam from the reference reflector with a returning beam from the sample to form a combined optical signal. The method further comprises using a detector for detecting contribution of the combined optical signal to two photon absorption in the detector, to provide an electrical signal. The method further comprises separating a low frequency component from the returning beam or the electrical signal, and using a data processor for providing a topographic reconstruction of the sample based, at least in part, on the low frequency component.

According to some embodiments of the invention the method comprises passing the combined optical signal through at least one optical element configured to form an image plane wherein the detecting is generally at the image plane.

According to some embodiments of the invention the separation is executed by a digital filter.

According to some embodiments of the invention the separation is executed by an analog filter.

According to some embodiments of the invention the method comprises: analyzing a carrier frequency component of the electrical signal; comparing the carrier frequency component with the low frequency component; and determining at least one property of the sample other than the topographic reconstruction.

According to some embodiments of the invention the at least one property comprises optical polarizability.

According to some embodiments of the invention the separation comprises modulating the returning beam.

According to some embodiments of the invention the separation comprises vibrating at least one of the sample and the reference beam.

According to some embodiments of the invention the method comprises moving the reference reflector at a spatial resolution of at least 20 nm to effect a depth scan in the sample.

According to some embodiments of the invention the method comprises moving the reference reflector at a spatial resolution of at least 2 μm to effect a depth scan in the sample.

According to some embodiments of the invention the reference reflector comprises an array of reflectors configured to provide a plurality of spatially separated reflected beams, wherein the method combines each of at least a portion of the reflected beams with the returning beam to form a plurality of combined optical signals, each corresponding to a different depth in the sample.

According to some embodiments of the invention the method comprises modulating at least one of the reflected beam and the returning beam and identifying a noise component in the electrical signal based on the modulation.

According to some embodiments of the invention the method performs time domain topographic reconstruction.

According to some embodiments of the invention the method performs frequency domain topographic reconstruction.

According to some embodiments of the invention the method comprises passing the optical beam through a monochromator and controlling the monochromator so as to dynamically vary a wavelength of the optical beam, wherein the frequency domain topographic reconstruction is responsive to the dynamic variation.

According to some embodiments of the invention the method comprises passing the combined optical signal through a monochromator and controlling the monochromator so as to dynamically vary a wavelength of the combined optical signal, wherein the frequency domain topographic reconstruction is responsive to the dynamic variation.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a schematic illustration of a system for optical coherence tomography (OCT) of a sample, according to some embodiments of the present invention;

FIG. 2 is a schematic illustration of two photon absorption employed in some embodiments of the present invention;

FIG. 3 is a schematic block diagram illustrating a two photon detector according to some embodiments of the present invention;

FIG. 4 is a schematic illustration of an experimental setup used in experiments performed according to some embodiments of the present invention; to FIGS. 5A-D shows first-order (FIGS. 5A and 5C) and second-order (FIGS. 5B and 5D) OCT signals of a single reflector, with (FIGS. 5C and 5D) and without (FIGS. 5A and 5B) a temporally variant phase, as obtained in experiments performed according to some embodiments of the present invention.

FIG. 6 shows sparsely sampled interferogram measured through temporally variant phase in experiments performed according to some embodiments;

FIG. 7A shows a second-order OCT signal measured in experiments performed according to some embodiments through spatially variant phase implemented using a phase-only SLM;

FIG. 7B is a schematic illustration of an experimental setup used for obtaining the data shown in FIG. 7A;

FIGS. 8A-B show representative results of experiments preformed according to some embodiments of the present invention using a superluminescent diode;

FIGS. 9A-C show representative results of experiments preformed according to some embodiments of the present invention using a single source with a single spectral lobe (FIG. 9A), a single source with two spectral lobes (FIG. 9B), and two sources (FIG. 9C);

FIG. 10A show representative results of experiments preformed according to some embodiments of the present invention using a quarter wavelength plate;

FIG. 10B is a schematic illustration of an experimental setup used for obtaining the data shown in FIG. 10A;

FIG. 11A shows peak envelope value as a function of the depth for first- and second-order OCT signals obtained by analysis performed according to some embodiments of the present invention; and

FIG. 11B is a schematic illustration visualizing frequency contents of the data shown in FIG. 11A.

### DESCRIPTION OF SPECIFIC EMBODIMENTS OF THE INVENTION

The present invention, in some embodiments thereof, relates to optics and, more particularly, but not exclusively, to a system and method for OCT.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The OCT technique according to some embodiments of the present invention is based on nonlinear optical phenomenon, particularly but not exclusively second-order coherence. Unlike first order coherence (also known as linear coherence), which is attributed to the autocorrelation of the electrical field, second and higher order coherences are attributed to the autocorrelation of higher moments of the electrical field. For example, second order coherence is attributed to the autocorrelation of light intensity (which is proportional to the power of the electrical field).

Nonlinear optical phenomena occur, inter alia, when the interaction between light and matter results in the creation of one electron-hole pair in response to the absorption of more than one photon. For example, a second order coherence can be measured from a photocurrent comprising one or more electron-hole pairs each created in response to the absorption of two phonons.

The first measurement of second order coherence was made using two photodetectors with their electrical outputs multiplied [Brown et al., “A Test of a New Type of Stellar Interferometer on Sirius,” Nature 177, 27 (1956)]. It was demonstrated that such a measurement carried the desired information but was not affected by phase variation. It is recognized, however, that the time resolution involved in the electronic multiplication at the output of the photodetectors is insufficient for OCT.

Although several attempts have been made to overcome this difficulty [Nasr et al., Lavoie et al., Pe'er et al., Lajunen et al., and Zerom et al., supra], it was found by the present inventors that these techniques are technologically difficult to employ or otherwise not practical.

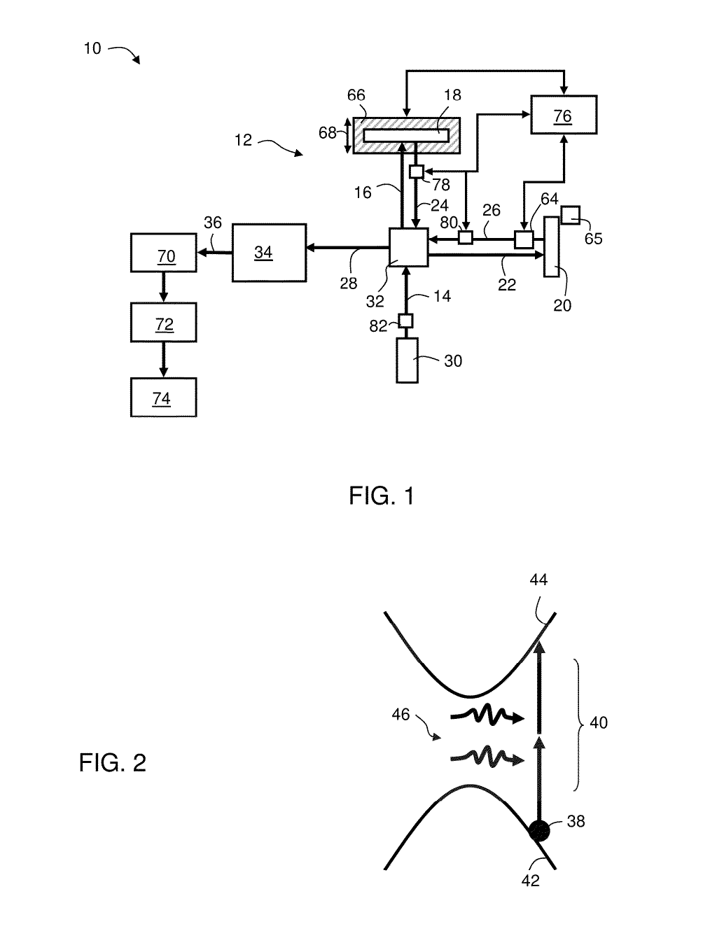

Referring now to the drawings, FIGS. 1A-B illustrate a system 10 for optical coherence tomography (OCT) of a sample 20, according to some embodiments of the present invention.

Sample 20 can be a biological sample, optionally at an anatomical location of a living subject. The anatomical location can be, for example, a lung, bronchus, intestine, esophagus, stomach, colon, eye, heart, blood vessel, cervix, bladder, urethra, skin, muscle, liver, kidney and blood vessel. Sample 20 can alternatively be a test biological sample in which case system 10 is used for ex-vivo examination.

Sample 20 can also be a non-biological sample. For example, sample 20 can be a non-biological object, such as a semiconductor wafer or device, an optical element, an electronic chip, an integrated circuit, a memory device, or any other industrial object.

System 10 comprises an optical interferometer apparatus 12 which splits an optical beam 14 into a reference optical beam 16 directed to a reference reflector 18 and a sample optical beam 22 directed to sample 20. Apparatus 12 combines a reflected beam 24 from reference reflector 18 with a returning beam 26 from sample 20 to form a combined optical signal 28. For clarity of presentation, beams 16 and 24, and beams 22 and 26 are illustrated offset from each other, but this need not necessarily be the case, since the returning and reflected beams can return generally along the propagation path of the reference and sample beams, respectively.

Typically, apparatus 12 comprises a light source 30 for generating beam 14 and a beam splitter 32 which is configured to receive beam 14 and to split it into beams 16 and 22, and also to receive beams 24 and 26 and to combine them into an optical beam representing the interference between beams 24 and 26 and referred to herein as combined optical signal 28. Beam splitter 32 optionally and preferably comprises linear optical elements such that the splitting and combining are linear optical effects.

The elements of apparatus 12 and sample 20 are typically arranged such that the optical path between beam splitter 32 and sample 20 is generally perpendicular to the optical path between beam splitter 32 and reflector 18.

In various exemplary embodiments of the invention reflector 18 is mounted on a translation stage 66. Stage 66 is optionally and preferably configured to establish a translation motion to reflector 18 in the direction of beam splitter 32 and in the opposite direction, as indicated by double arrow 68. Such motion effect a change in the optical path difference within apparatus 12 as known in the art. Stage 66 is optionally and preferably controlled by a control unit shown at 76. Stage 66 is particularly useful for to providing time domain OCT, wherein the repositioning of reference reflector 18 with respect to beam splitter 32 allows system 10 to perform depth scan.

Typical spatial resolutions of stage 66 can be from about 0.05 to about 0.25 of the wavelength of the source, or from about 0.25 to about 0.5 of the coherence length or pulse width (when a pulsed source is employed).

The former range of spatial resolutions (0.05-0.25 of the wavelength) is particularly useful when system 10 employs high rate sampling that is suitable for digital extraction of information from the complete interferogram. Typically, the sampling rate is at least the ratio between the linear speed of stage 66 and its sampling resolution. As a representative example, consider a 1.3 μm light source and a linear speed of about 1 m/s. In this case, for a spatial resolution of from about 65 nm to about 325 nm, a sampling rate of less than 16 MHz and more than 3 MHz, respectively, can be employed.

The latter range of spatial resolutions (from about 0.25 to about 0.5 of the coherence length or pulse width) is particularly useful when system 10 employs low rate sampling that is suitable for digital extraction of information only from low frequency components of the interferogram. As a representative example, consider a linear speed of about 1 m/s and a 1.3 μm light source with a coherence length of 14 μm. In this case, for a spatial resolution of from about 3.5 μm to about 7 μm, a sampling rate of less than 145 KHz and more than 70 KHz, respectively, can be employed.

In some embodiments, reference reflector 18 comprises an array of reflectors configured to provide a plurality of spatially separated reflected beams (not shown). In these embodiments, each of the reflected beams is brought to interact with the sample beam separately, by directing the respective reflected beam to a selected location on the entry facet of beam splitter 32 and/or by employing a respective array of beam splitters.

Light source 30 can be selected to generate any type of light, including, without limitation, thermal-like light, coherent pulsed light and chaotic light. In thermal-like light, there is a phase incoherence and relatively large intensity noise. Suitable light sources for producing thermal-like light include, without limitation, Light Emitting Diode (LED) source, and superluminescent diodes (SLD). In coherent pulsed light, there is a well-defined phase and the intensity noise is much smaller than in thermal-like light, while it is temporally and/or spatially confined. In chaotic light, the light source to includes a plurality of light emitting atoms, wherein the emissions occur at random times, generally without correlation between individual emissions.

Suitable coherent light sources include laser sources such as, but not limited to, pulsed fiber laser, mode-locked laser, and a Q-switched laser. Suitable incoherent light sources preferably have a higher value at the symmetry point τ=0 of their second order coherence function than at any other point (TA), and include without limitation, Amplified Spontaneous Emission (ASE) light source, Super-luminescent diode (SLD) and a thermal light source such as a halogen light source, preferably with sufficiently short coherence lengths, e.g., below 100 μm. Suitable chaotic light sources for the present embodiments are sources having a second-order coherence function which is proportional to the square of the first-order coherence function. In various exemplary embodiments of the invention light source 30 is a chaotic light source implemented as an ASE light source.

System 10 further comprises a two photon detector 34 configured to detect optical signal 28 by two photon absorption and to provide an electrical signal 36. The two photon detector 34 can be of any type, such as, but not limited to, two photon detector 34 disclosed in Roth et al., “Ultrasensitive and high-dynamic-range two-photon absorption in a GaAs photomultiplier tube,” Opt. Lett. 27, 2076 (2002). Generally, a two photon detector 34 includes a photocathode characterized by an energy gap selected such that a simultaneous absorption of two photons excites an electron-hole pair which in turn provides a signal.

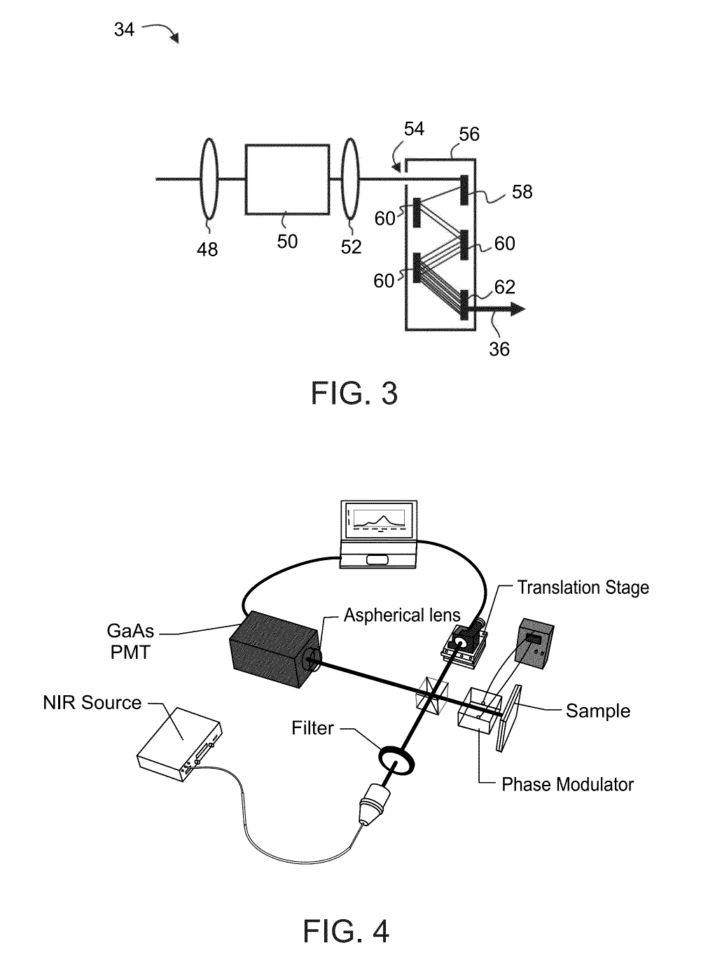

The concept of two photon absorption is illustrated schematically in FIG. 2. A pair 46 of photons excites an electron 38 to cross an energy gap 40 between a valence band 42 and a conduction band 44.

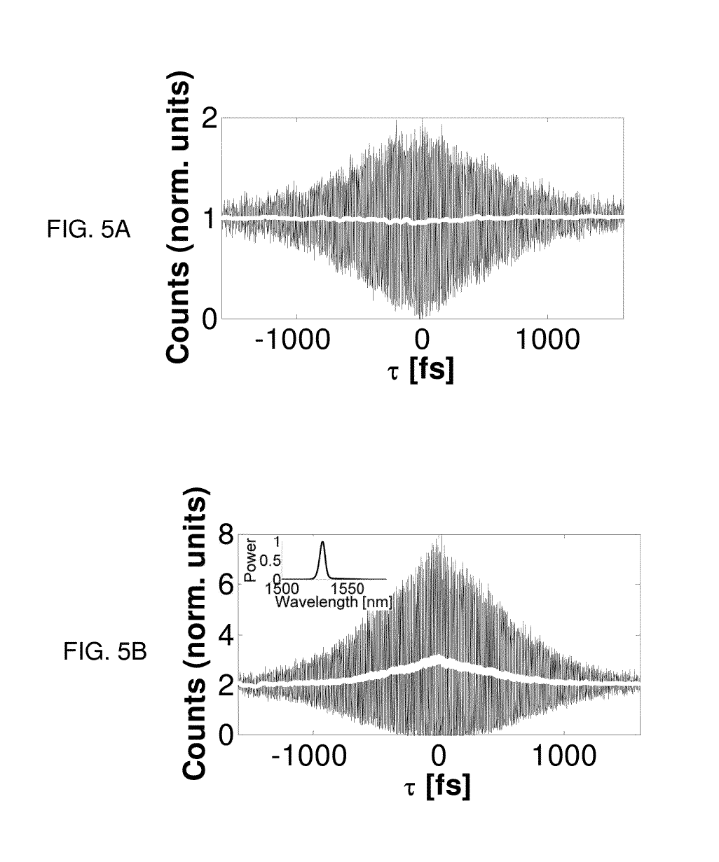

FIG. 3 is a schematic block diagram illustrating a two photon detector suitable to be used as detector 34 according to some embodiments of the present invention. Signal 28 can optionally be collimated by a collimating optical element 48 (e.g., a collimating lens). If desired, signal 28 can be filtered by an optical filter 50. The signal then enters an aperture 54 of photomultiplier tube 56. Optionally, an optical element 52 is placed at or near aperture 54 such that the signal enters photomultiplier tube 56 through element 52.

In photomultiplier tube 56, optical signal 28 incidents on a photocathode 58 which releases an electron by the aforementioned two photon absorption mechanism. The electron is accelerated within an arrangement of dynodes 60. The dynodes 60 effect electron multiplication as known in the art. The multiplied electrons are collected at an anode 62 thereby producing electrical signal 36.

Detector 34 can be provided as an integrated unit (e.g., enclosed in a single casing) including photomultiplier tube 56, appropriate circuitry (not shown) for accelerating the electrons and outputting signal 36, and one or more of elements 48, 50 and 52, if present. Alternatively, detector 34 can include only tube 56 and the circuitry, wherein elements 48, 50 and 52 can be physically separated therefrom.

In various exemplary embodiments of the invention at least one of optical elements 48 and 52 is positioned such that the optical signal is imaged onto aperture 54 of tube 56. This can be done by placing aperture 54 at the image plane of, e.g., an optical system including elements 48 and 52. This is contrary to conventional systems in which element 52 is a focusing element which focuses the incoming light to a point-like spot at aperture 54. In some embodiments of the present invention element 52 includes an objective with a high numerical-aperture such as, but not limited to, an aspherical lens.

The advantage of imaging the optical signal onto aperture 54 is that it increases the amount of optical energy that can be exploited for the detection. Conventional techniques focus the incoming light onto the aperture so as to reduce effects caused by phase variations. Focusing the two light beams results in larger spot size for the beam from the sample due to the random phase variations over its cross-section. This leads to a relatively large area on the detector which does not overlap the reference signal, and therefore does not contribute to an interference signal but does contribute to a background signal. The imaging employed according to the present embodiments generates images of the two beams that are similar in their diameter and different in phases. Since the second-order coherence of the present embodiments is less sensitive to phase variations, most or all the light energy reflected from the sample can be exploited.

Since the two-photon absorption signal is inversely proportional to the area of the cross section of the light beam impinging the detector, the image of the incoming light is preferably sufficiently small so as to provide sufficiently high SNR.

It was found by the inventors of the present invention that it is advantageous to separate the low frequency components from the electrical signal. It was found by the present inventors that use of low frequency components is advantageous when these components are not strongly attenuated due to phase variations in the sample. Use of low frequency allows, for example, sampling the electrical signal at relatively low rates (e.g., on the order of several tens of KHz).

In particular, the present inventors found that for the purpose of topographic reconstruction from intensity-intensity correlation, it is advantageous to separate a DC component or frequencies close to the DC component. Thus in various exemplary embodiments of the invention system 10 separates frequency components which are less than a predetermined cutoff frequency ω_{c}.

The value of ω_{c} is optionally and preferably less than half the frequency of the optical beams as expressed in a reference frame in which the time axis is the time delay τ between the arms of the interferometer. The frequency of an external reference frame (e.g., the reference frame of the detector) can be calculated using a linear transformation. For example, when the reference reflector is a moving reflector, the relation between the interferometer time t and the detector time t is given by t=τc/(2v) where c is the speed of light and v is the velocity of the reflector. For example, for a 1.3 μm light source, the optical frequency is 230×10¹² Hz so that ω_{c} is preferably lower than 115×10¹² Hz. In this example, if the reference mirror moves at a speed of v=1 m/s, then, cutoff frequency in the reference frame of the detector is 230×10¹²×(2×1/(3×10⁸))=384 KHz.

In some embodiments of the present invention system 10 also uses higher frequency components, for example, a carrier frequency or the sum or difference between the carrier frequencies of beams 24 and 26. In these embodiments, the higher frequency components are preferably used in addition to the low frequency components. Embodiments in which the higher frequency components are preserved are particularly useful when the sampling rate of the electrical signal is relatively high (e.g., on the order of a few MHz).

The separation of low frequency component according to various embodiments of the present invention is performed by a frequency separation system which can be embodied in more than one way.

In some embodiments of the invention the frequency separation system is embodied as an optical device 64 positioned at the optical path of returning beam 26, preferably between sample 20 and beam splitter 32. Optical device 64 preferably modulates beam 26. The modulation of beam 26 effects an erasure of the high frequency interference terms in the detection process performed by detector 34, hence separates the low frequency components from the electrical signal 36.

In some embodiments of the present invention optical device 64 is an electro-optical device which modulates the beam in response to voltage applies to device 64. Representative examples for optical device 64 include, without limitation, a high frequency modulator or a phase modulator, e.g., an electro-optic phase modulator.

The principles and operation of electro-optic phase modulator are known and found in many text books. Briefly, in an electro-optical modulator a varying electrical voltage is applied between a pair of electrodes mounted on opposite faces of a crystal to create electric field stresses within the crystal. The optical beam propagating through the crystal intermittently interacts with the modulating electrical field resulting in a modulated optical beam exhibiting Faraday phase rotation. An electro-optic phase modulator suitable for the present embodiments is commercially available from Thorlabs Inc., U.S.A.

In various exemplary embodiments of the invention the voltage applied to the phase modulator varies at a frequency selected such as to impose a few (e.g., from about 2 to about 20) cycles of phase variation from 0 to 2π within the integration time of detector 34. The voltage can be varied according to any wave shape, including, without limitation, triangular wave, sine wave, saw tooth wave and the like. In various exemplary embodiments of the invention triangular wave is used. The voltage to optical device 64 can be applied using a dedicated controller (not shown) or via control unit 76.

In some embodiments of the present invention the frequency separation system is embodied as a vibrating unit 65 which vibrates the sample and/or reference arm of the interferometer in order to generate the aforementioned phase variation. The effect of such vibration is similar to the effect of a phase modulator.

In some embodiments of the present invention the separation of low frequency component can be done after the electrical signal 36 is formed. For example, the frequency separation system can comprise an analog or digital filter which filters electrical signal 36 to obtain the low frequency content.

In some embodiments of the present invention signal 36 is digitized, e.g., by a digitizer 70 such as an Analog-to-Digital converter (ADC). In these embodiments, the separation of low frequency component can be performed digitally, e.g., by a digital frequency separation system generally shown at 72. System 72 is typically a low pass digital filter, which can be embodied as a separate unit, as shown in FIG. 1, or as a low pass digital filter software module accessible by a data processing apparatus 74.

In some embodiments of the present invention the sampling rate of digitizer 70 is about twice the optical bandwidth near the threshold frequency ω_{c} expressed in a reference frame in which the time axis is the time delay τ, as further detailed hereinabove. Representative sampling rates in these embodiment are from about 10 THz to about 30 THZ, e.g., about 20 THz, in the reference frame in which the time axis is the time delay τ. This sampling rate can be reduced even further if a preliminary assumption on the number of reflectors within the sample can be made.

For example, suppose that the sample is assumed to include a set of K distinct reflectors, so that the tomogram is affected by 2K parameters (K locations and K reflectance coefficients of the reflectors). Under this assumption, a set of 2K samples may suffice for determining the 2K unknowns. This can be done, for example, by using the technique outlined in Michaeli and Eldar, “Xampling at the rate of innovation,” IEEE Transactions on Signal Processing, 60(3), pp. 1121-1133, (2012). These embodiments are particularly useful when the separation of low frequency component is performed using optical frequency separation system 64.

In some embodiments of the present invention the sampling rate of digitizer 70 is about four times the optical bandwidth near the threshold frequency ω_{c} expressed in a reference frame in which the time axis is the time delay τ. Representative sampling rates in these embodiment are from about 800 THz to about 1200 THZ, e.g., about 1000 THz, in the reference frame in which the time axis is the time delay τ.

Data processing apparatus 74 can be embodied as a general purpose computer or dedicated circuitry. Irrespectively of the technique employed for separating the low frequency component, data processing apparatus 74 provides a topographic reconstruction of sample 20 based on the separated low frequency component. The topographic reconstruction can be done using any computerized tomography (CT) procedure known in the art. The present inventors contemplate both time domain topographic reconstruction and frequency domain topographic reconstruction.

When frequency domain topographic reconstruction is employed, light source 30 is preferably SLD. Optionally and preferably, the light 14 from source 30 is filtered through a controllable monochromator 82 to provide scanning in the frequency domain at the input. Also contemplated, are embodiments in which monochromator 82 or a spectrometer is placed before detector 34.

Representative examples of CT procedures suitable for the present embodiments are found in M. E Brezinski, Optical Coherence Tomography: Principles and Applications, Academic Press, New York, 2006. Data processing apparatus 74 can communicate with control unit 76, for synchronization purposes. For example, apparatus 74 can transmit signals to unit 76 to relocate reflector 18 closer or farther from beam splitter 32, thereby to vary the optical path difference in optical interferometer apparatus 12 and to allow system 10 to acquire topographic reconstructions at different depths within sample 20.

In some embodiments of the present invention, a carrier frequency component of the electrical signal 36 is used for assessing one or more properties of sample 20 other than its topographic reconstruction. A representative example of such property is optical polarizability.

It was found by the present inventors that the ability of sample 20 to polarize or change the polarization of the light can be assessed by comparing the amplitude of the signal at the carrier frequency to the amplitude of the signal at the low, DC-like, frequencies. Specifically, comparable amplitudes indicate that the interaction between the light and the sample results in little or no change in the polarization of the light, and substantially different amplitudes indicate that the interaction between the light and the sample results in significant change in the polarization of the light.

Generally, the carrier frequency is the frequency of the photons in beams 24 and 26 and their sum and difference frequencies. Since detector 34 operates according to the two photon absorption mechanism, the carrier frequency can be either the frequency of each single absorbed photon, or the sum or difference of frequencies of the two absorbed photons (e.g., twice the frequency of one photon, for a pair of identical photons).

In some embodiments of the present invention system 10 comprises optical modulators 78, 80 configured to apply amplitude modulation (AM) to reflected beam 24 and returning beam 26. Modulators 78 and 80 are preferably controllable modulators, e.g., an electro-optical modulators which modulates the amplitude of the respective beam responsively to an external voltage bias. Modulators 78 and 80 can be controlled by a dedicated controller or by control unit 76.

The amplitude modulations optionally and preferably differ for beams 24 and 26. For example, the amplitude modulations can be at different frequencies. The electrical output signal can then be demodulated synchronically according to the difference AM frequency.

The advantageous of such modulation is that it allows improving the signal-to-noise ratio (SNR) in system 10. Thus, in various exemplary embodiments of the invention data processing apparatus 74 identifies noise component in signal 36 based on the controlled modulation. This can be done in the following manner. Denote the intensity associated with beams 24 and 26 by I₁ and I₂, respectively. Since beams 24 and 26 are at different and distinguishable frequencies, apparatus can perform a frequency analysis of the digitized signal and identify a component proportional to |I₁|², a component proportional to |I₂|² and a component proportional to I₁I₂. Components proportional to |I₁|² and |I₂|² can be identified as noise components and are optionally and preferably filtered out. The remaining portion of the signal, which is proportional to I₁I₂, is indicative of the interference between beams 24 and 26 and is characterized by an enhanced SNR.

As used herein the term “about” refers to ±10%.

The word “exemplary” is used herein to mean “serving as an example, instance or illustration.” Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments.” Any particular embodiment of the invention may include a plurality of “optional” features unless such features conflict.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination to in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Various embodiments and aspects of the present invention as delineated hereinabove and as claimed in the claims section below find experimental support in the following examples.

### EXAMPLES

Reference is now made to the following examples, which together with the above descriptions illustrate some embodiments of the invention in a non limiting fashion.

### First- and Second-Order Coherence

One of the underlining features of conventional first-order OCT is that the first-order temporal coherence function of a broadband optical source, implemented either directly by broadband emission or using a swept laser source, is very narrow and localized around the symmetry-point of the interferometer. For a sample with multiple reflectors, a symmetry point exists for each reflector, resulting in a superposition of temporal coherence functions localized around each reflector location. The amplitude of each of these functions is proportional to the value of the corresponding reflectivity.

Assuming no polarization changes, no lateral spatial variations and no temporal phase variations while propagating through the sample, the normalized output signal as a function of the time difference between the arms of the interferometer, τ (which can be translated to distance using the speed of light in vacuum), is:

$${S}^{( 1 )} ( τ ) = 〈 {\vert E ( t - τ ) + {\sum }_{k} {a}_{k} E ( t - {t}_{k} ) \vert}^{2} 〉 .$$

Written explicitly, this expression leads to:

$${S}^{( 1 )} ( τ ) = {C}_{1} + {\sum }_{k} {a}_{k} {g}^{( 1 )} ( τ - {t}_{k} ) , \qquad ( 1 )$$

wherein

$${C}_{1} = \frac{1}{2} ( 1 + {\sum }_{k} {\sum }_{l} {a}_{k} {a}_{l} {g}^{( 1 )} ( {t}_{k} - {t}_{l} ) )$$

is a background term independent of τ, aₖ is the magnitude of the reflection-coefficient of the kth reflector, tₖ is the time-domain location of the kth reflector with respect to the symmetry point of the interferometer, and g⁽¹⁾(τ) is the (real) first-order coherence function of the light source,

$${g}^{( 1 )} ( τ ) = Re \{ \frac{〈 {E}^{*} ( t ) E ( t + τ ) 〉}{〈 {E}^{*} ( t ) E ( t ) 〉} \} ,$$

with E(t) being the electric field at time t. For a chaotic source with Lorentzian line shape, for example, g⁽¹⁾(τ) is given by

$${g}^{( 1 )} ( τ ) = exp [ - \frac{\vert τ \vert}{{τ}_{c}} ] cos ( {ω}_{0} τ ) ,$$

where τ_{c} is the coherence time of the source and ω₀ is the optical carrier frequency. The interferogram in EQ. 1 presents a scan as a function of depth in OCT, which is also referred to in the literature as “A-scan”. The localization of the coherence function determines the resolution and is dictated by the coherence time of the source. The profile of the refractive index within the medium is encoded in the last term of EQ. 1, which is modulated by the carrier frequency, ω₀. Therefore, either envelope detection or demodulation is typically used to extract the tomographic information.

In practice, since the imaged sample can be optically dense, it does not conform to this simplified model of a collection of flat specular reflectors. For example, different ingredients of soft tissues, including protein macromolecules, a gelatinous matrix of collagen and elastin fibers packed with cells, blood vessels, nerves, and numerous other structures, result in inhomogeneities in the refractive index with dimensions ranging from less than 100 nm to more than several millimeters [J. M. Schmitt, “Optical coherence tomography (OCT): A review,” IEEE J. Sel. Top. Quantum Electron. 5, 1205-1215 (1999)].

Moreover, multiple scattering results in variant phase of the photons collected from the sample. This can lead to a spatially variant phase of the image of the sample on the detector. Furthermore, subwavelength sample motion or temporal turbulence of the medium between the sample and the detector, such as blood-flow in cardiovascular applications [T. Kubo , T. Asakura, “Optical coherence tomography imaging: current status and future perspectives,” Cardiovasc Intery Ther. 25, 2-10 ,(2010)], result in phase variations as a function of time within the integration-time of the detector.

Taking the above effects into account, even for a sample consisting of perfect reflectors, the output of the detector from Eq. 1, is modified to:

$${\tilde{S}}^{( 1 )} ( τ ) = {\int \int }_{A} {\int }_{0}^{T} {S}^{( 1 )} ( τ - Δ τ ( x , y , t ) ) d x d y d t \qquad ( 2 )$$

where ω₀Δτ(x, y, t) is the phase variation at time t and location (x, y) within the beam's spot on the detector. For a given spatiotemporal distribution of Δτ(x, y, t), due to the oscillatory nature of S⁽¹⁾(τ), the larger the beam's cross section A or the integration time T are, the larger is the probability of \tilde{S}⁽¹⁾(τ) to be attenuated. If, for example, A and T are large and ω₀Δτ varies uniformly over [−π, π], due to either temporal or spatial fluctuations, then the last term in EQ. 1 almost completely vanishes, resulting in \tilde{S}⁽¹⁾(τ)≈C₁. In this case, no information about the reflector locations is present in the measured signal, and the phase fluctuations act as a low-pass filter in the interferogram domain.

For Second Order OCT (SO-OCT), S⁽²⁾(τ) is given by

$${S}^{( 2 )} ( τ ) = 〈 {\vert E ( t - τ ) + {\sum }_{k} {a}_{k} E ( t - {t}_{k} ) \vert}^{4} 〉 .$$

Unlike a regular one-photon detector, a two-photon detector measures the second-order coherence of the impinging light, which can be considered as intensity-intensity correlation, so that the second order coherence function g⁽²⁾(τ) can be written as:

$${g}^{( 2 )} ( τ ) = \frac{〈 I ( t ) I ( t + τ ) 〉}{{〈 I ( t ) 〉}^{2}} ,$$

where I(t) is the light intensity at time t.

To obtain localized functions the light source is preferably pulsed or bunched. In the present example, a chaotic source in which the photons are bunched is considered. This leads to an enhanced correlation around the symmetry point of the interferometer. Since chaotic light comprises numerous contributions of independent emissions, its electric field is a Gaussian random process. The fourth-order moment of a zero-mean Gaussian variable equals three times its squared second-order moment, so that the SO-OCT measurement can be expressed as:

$$\begin{matrix}{S}^{( 2 )} ( τ ) = 〈 {\vert E ( t - τ ) + {\sum }_{k} {a}_{k} E ( t - {t}_{k} ) \vert}^{4} 〉 \\ = 3 {〈 {\vert E ( t - τ ) + {\sum }_{k} {a}_{k} E ( t - {t}_{k} ) \vert}^{2} 〉}^{2} \\ = 3 {( {S}^{( 1 )} ( τ ) )}^{2}\end{matrix} \qquad ( 6 )$$

It was found by the present inventors that this information is located around DC in the frequency content of the interferogram, together with contents around ω₀, and around 2ω₀. While spatial and temporal integration, as in EQ. 2, attenuates the high frequency terms due to sub-wavelength variations in ΔT (x, y, t), it has low effect on the content around DC. This allows extracting information on the locations of the reflectors in a manner that is insensitive to spatial and temporal phase fluctuations. Substituting EQ. 1 in EQ. 6 and separating the low frequency terms, this expression leads to EQ. 3, the low-frequency (around DC) part of S⁽²⁾(τ) for a chaotic light source, is given by

$${S}_{LF}^{( 2 )} ( τ ) = {C}_{2} + {\sum }_{k} {a}_{k}^{2} exp [ - \frac{2 \vert τ - {t}_{k} \vert}{{τ}_{c }} ] + {\sum }_{k} {\sum }_{l \neq k} {a}_{k} {a}_{l} cos ( {ω}_{0} ( {t}_{k} - {t}_{l} ) ) exp [ - \frac{\vert τ - {t}_{k} \vert + \vert τ - {t}_{l} \vert}{{τ}_{c}} ] \qquad ( 3 )$$

where C₂=C₁² is the background level.

Reflectors satisfying |tₖ−tₗ|>>τ_{c} can be considered sufficiently separated. For such separators, the last term in EQ. (3) can be neglected, so that the scan comprises a combination of shifted second-order coherence functions. In the present example, this can be written as:

$${g}^{( 2 )} ( τ ) = 1 + exp [ - \frac{2 \vert τ \vert}{{τ}_{c}} ]$$

at the reflectors' locations.

The low frequency term of S⁽²⁾(τ) is predominantly affected by phase variations which are on the order of the coherence-time, while phase variations on the order of the optical time-period can be neglected. Therefore, for sub-wavelength variations,

$${\tilde{S}}^{( 2 )} ( τ ) = \int {\int }_{A} {\int }_{0}^{T} {S}^{2} ( τ - Δ τ ( x , y , t ) ) d x d y d t ≅ {S}_{LF}^{( 2 )} .$$

In a theoretical article by Lajunen et al. [“Resolution-enhanced optical coherence tomography based on classical intensity interferometry,” J. Opt. Soc. Am. A 26, 1049-1054 (2009)] it was indicated that since g⁽²⁾(τ) has half the decay-time of g⁽¹⁾(τ), it provides improved resolution. However, the present inventors found that this analysis does not take into account the last term in EQ. 3 which becomes significant when measuring two adjacent reflectors.

### Experimental Study

### Methods

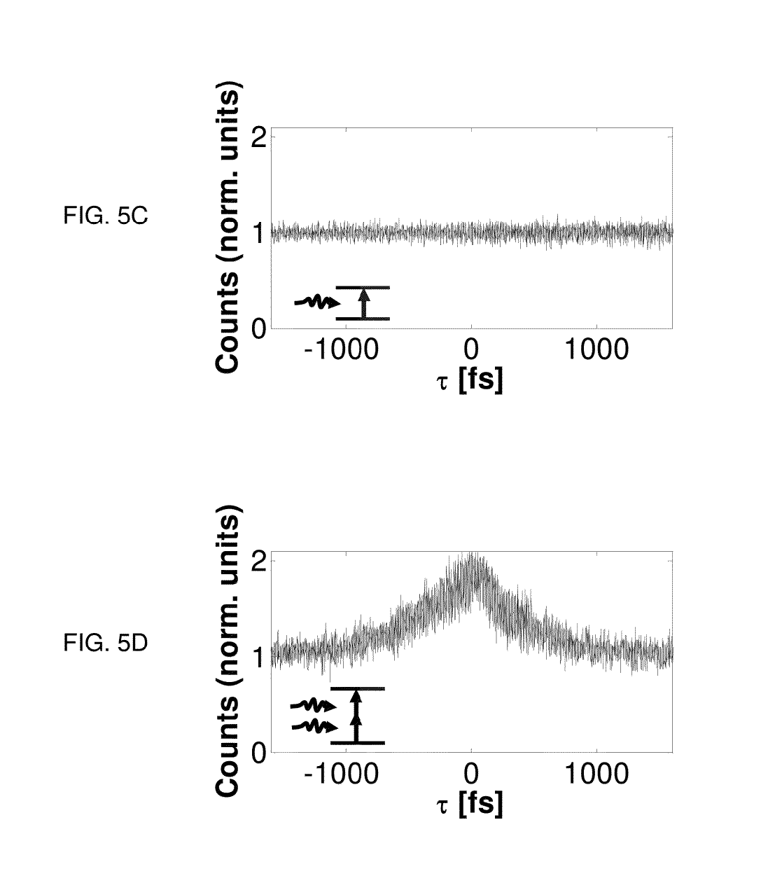

An OCT system was constructed and studied according to some embodiments of the present invention. The experimental setup is illustrated in FIG. 4.

### Second-Order Coherence Setup

The chaotic radiation sources were implemented either by an EDFA with 17dBm maximal output at fixed gain (manufactured by RED-C), or by this source combined with an EDFA with 30 dBm maximal output variable gain (Keopsys). The output powers were controlled using the variable gain and using constant fiber attenuators, attaining a level of about 200 μW at the detector. The optical radiation was coupled from the fibers to free space using a collimator-lens and was filtered by a 300 μm thick Silicon layer, absorbing any undesired low wavelength emission which may be detected by one-photon absorption in the detector. The wide spread of the collimated beam renders any nonlinear processes in the Silicon negligible.

Subsequently, the optical radiation was inserted into a computer-controlled Michelson interferometer incorporating a broad-band beamsplitter (1100 nm-1600 nm), and a translation stage with 50 nm resolution (Thorlabs DRV001). A GaAs PMT detector (Hamamatsu H7421-50) was used for efficient two photon absorption (TPA) at the wavelength range of 1500 nm-1600 nm. The Michelson interferometer and the detector were placed inside a light-shield to reduce background detections.

The signal was imaged on the PMT detector by an aspherical lens with focal length of f=25 mm and numerical aperture of 0.5. In the experiments with the combined chaotic sources the sample was constructed from a 150 μm microscope glass covered at its front side with 10 nm of gold and at its back side with 200 nm of gold, generating a partial reflector followed by a perfect reflector.

### First-Order Coherence Setup

The output from the Michelson interferometer was attenuated, coupled to a fiber and connected to an InGaAs single-photon detector (Princeton Lightwave).

### Temporal Phase Modulation

Electro-optic phase modulator for wavelength: 1250-1650 nm (Thorlabs EO-PM-NR-C3) was placed before the sample, modulated by a triangular voltage wave at a frequency of 10 kHz, resulting in 10 cycles of phase variation from 0 to 2π within the integration time of the detector. The optical input was linearly polarized and aligned with the extraordinary axis of the modulator crystal, resulting in a pure phase shift with no change in the state of polarization.

### Spatial Phase Modulation

The sample was replaced with a phase only Microdisplay (HOLOEYE HED 6010 TELCO) optimized for 1550 nm with a resolution of 1920×1080 pixels and pixel pitch of 8 μm. A random bitmap image was used generating ˜2000 random phase elements within the cross-section of the beam.

### Derivation of Attenuation Factor

To analyze the attenuation factor, the following relation for the refractive index was used:

n(x, y, z)= n̅+δn(x, y, z),

where δn(x, y, z) is an isotropic Gaussian random field. In biological tissues, the spatial spectrum corresponding to a 2D slice δn(x, y, 0), can be written as:

$$\frac{4 π 〈 δ {n}^{2} 〉 {L}_{0} ( m - 1 )}{{( 1 + {L}_{0}^{2} {‖ ω ‖}^{2} )}^{m}} \qquad ( 7 )$$

where ω=(ωₓ, ω_{y}) is the spatial frequency, [symbol] δn² [symbol] is the field's variance and L₀ is a scale parameter, referred to as the outer scale of the field. For most tissues, the value of m is between about 1.28 and about 1.41. For m=1.5, the corresponding autocorrelation function is

$$\begin{matrix}〈 Δ {τ}^{2} 〉 = 〈 {( \frac{1}{c} {\int }_{0}^{L} δ n ( 0 , 0 , z ) d z )}^{2} 〉 \\ = \frac{1}{{c}^{2}} {\int }_{0}^{L} {\int }_{0}^{L} {R}_{δ n} ( {z}_{1} - {z}_{2} ) d {z}_{1} d {z}_{2} \\ = \frac{2 {L}_{0} 〈 δ {n}^{2} 〉}{c} ( L - {L}_{0} ( 1 - {e}^{- \frac{L}{{L}_{0}}} ) )\end{matrix} \qquad ( 8 )$$

where d is the displacement length. In this situation, if a perfect reflector is placed at a distance of L/2 below the surface, then f_{Δτ}(η) is a Gaussian function with mean zero and variance

$${R}_{δ n} ( d ) = 〈 δ {n}^{2} 〉 {e}^{- \frac{d}{{L}_{0}}} ,$$

where c is the speed of light.

For a chaotic source with Gaussian broadening g⁽¹⁾(τ) is given by:

$${g}^{( 1 )} ( τ ) = exp [ - \frac{π {τ}^{2}}{2 {τ}_{c}^{2}} ] cos ( {ω}_{0} τ ) ,$$

so that the convolution integral can be calculated in closed form, yielding

$${\tilde{S}}^{( 1 )} ( τ ) = α exp [ - \frac{π {τ}^{2}}{2 {\tilde{τ}}_{c , 1}^{2}} ] cos ( {\tilde{ω}}_{0} τ ) , \qquad ( 9 )$$

where,

$${\tilde{τ}}_{c , 1}^{2} = {τ}_{c}^{2} + π 〈 Δ {τ}^{2} 〉 , \tilde{ω} = \frac{{τ}_{c}^{2}}{{\tilde{τ}}_{c}^{2}} {ω}_{0} ,$$

and the attenuation factor α₁ is given by

$${α}_{1} = \frac{{τ}_{c}}{{\tilde{τ}}_{c , 1}} exp \{ - \frac{{τ}_{c}^{2} {ω}_{0} 〈 Δ {τ}^{2} 〉}{2 {\tilde{τ}}_{c 1}^{2}} \} \qquad ( 10 )$$

For the same setting,

$${g}^{( 2 )} ( τ ) = 1 + exp [ - \frac{π {τ}^{2}}{{τ}_{c}^{2}} ] ,$$

and similar computation reveals that the low-frequency term of the SO-OCT becomes

$${\tilde{S}}^{( 2 )} ( τ ) = 1 + {α}_{2} exp [ - \frac{π {τ}^{2}}{{\tilde{τ}}_{c , 2}^{2}} ] , \qquad ( 11 )$$

where \tilde{τ}_{c,2}²=τ_{c}²+2π [symbol] Δτ² [symbol] and attenuation factor

$${α}_{2} = \frac{{τ}_{c}}{{\tilde{τ}}_{c , 2} } .$$

### Results

FIG. 5A shows first-order OCT signal of a single reflector resulting in a high-frequency carrier (black) multiplied by exponential decaying envelope, in addition to a to constant background (white). FIG. 5C shows first-order OCT through temporally variant phase. The inset in FIG. 5C is a schematic of one-photon absorption.

FIG. 5B shows second-order OCT signal of a single reflector resulting in low frequency content which is close to DC (white), in addition to high frequency terms (black). The inset in FIG. 5B is the spectrum of the source. FIG. 5D shows a second-order OCT signal through temporally variant phase. The inset is a schematic of two-photon absorption.

As a first demonstration of the robustness of the system of the present embodiments to temporal turbulence a phase-modulator was inserted in the sample-arm of the interferometer modulated by a triangular wave in the range [−π,π] within the integration time of the detectors, with the sample being a perfect reflector.

The chaotic light source was implemented by amplified spontaneous emission (ASE) around a wavelength of 1.53 μm (FIG. 5B inset) from Er³⁺-doped fiber amplifier (EDFA) with a coherence time of τ_{c,L}=1170 fs. Under these conditions, and using linear detection by a first-order InGaAs detector, the measurement yielded a flat background (FIG. 5C) with no indication of the reflector's location.

Replacing the detector with a GaAs PMT, which measures the signal by two-photon detections only, the existence of the reflector is clearly revealed, while the phase variations only attenuate the ω₀ and ω₀ components of the interferogram. Since the information located around ω₀ in the second-order interferogram is identical to that of a first-order measurement, the fact that no fringes are observed in the second order experiment would have sufficed by itself to conclude that the first-order signal (namely the regular OCT signal) is completely erased under the same conditions.

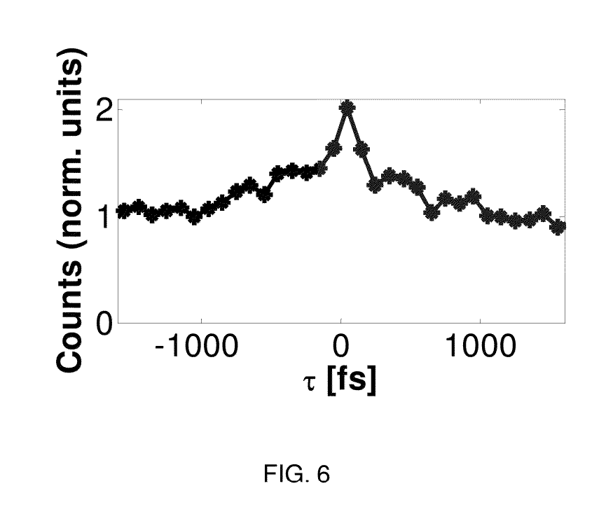

It is noted that the fringe erasure is by itself a unique feature of SO-OCT, as deliberate phase variations may be added to the system, resulting in an interferogram to with a DC term only. Such an interferogram can be sampled at much lower sampling rates resulting in a significant increase in scan speed. FIG. 6 shows sparsely sampled interferogram measured through temporally variant phase. The deliberate turbulence erases the high frequencies of the interferogram enabling an ultralow sampling rate.

Taking into account the unique structure of the signal, an advanced sub-Nyquist sampling methods can be applied thereby allowing even further reduction in sampling rates.

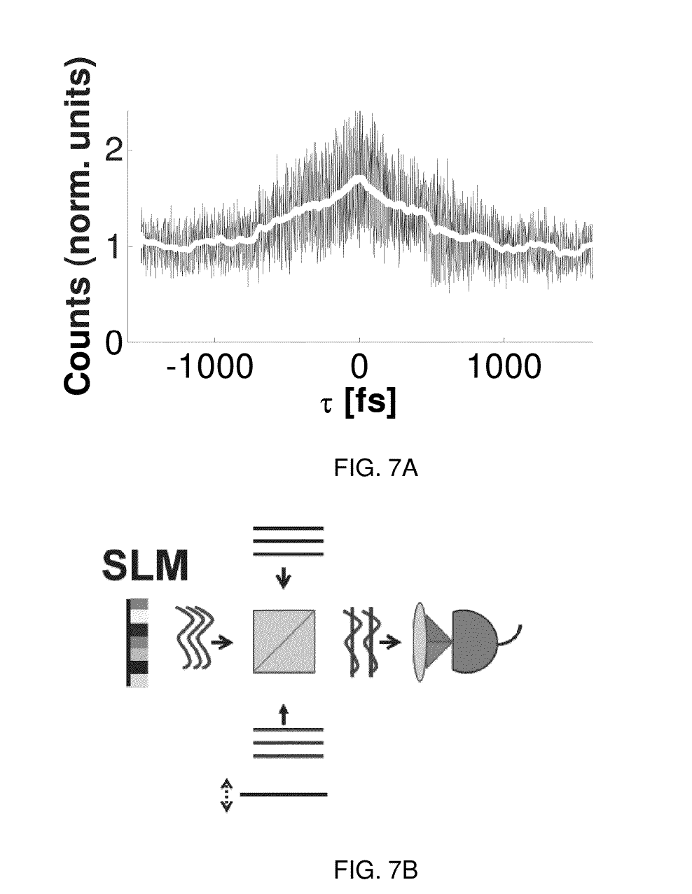

In order to demonstrate the tolerance of SO-OCT to spatial phase variations along the cross-section of the beam, the perfect reflector was replaced with a phase-spatial light modulator (SLM) incorporating a reflector at its back side. A random picture of phases from 0 to 2π was generated on the SLM, resulting again in a significant decrease in the visibility of the fringes while retaining the shape of g⁽²⁾(τ) of the signal. A second-order OCT signal through spatially variant phase implemented using a phase-only SLM is shown in FIG. 7A. The high and low frequency contents are shown in black and white, respectively. FIG. 7B is a schematic illustration of the setup.

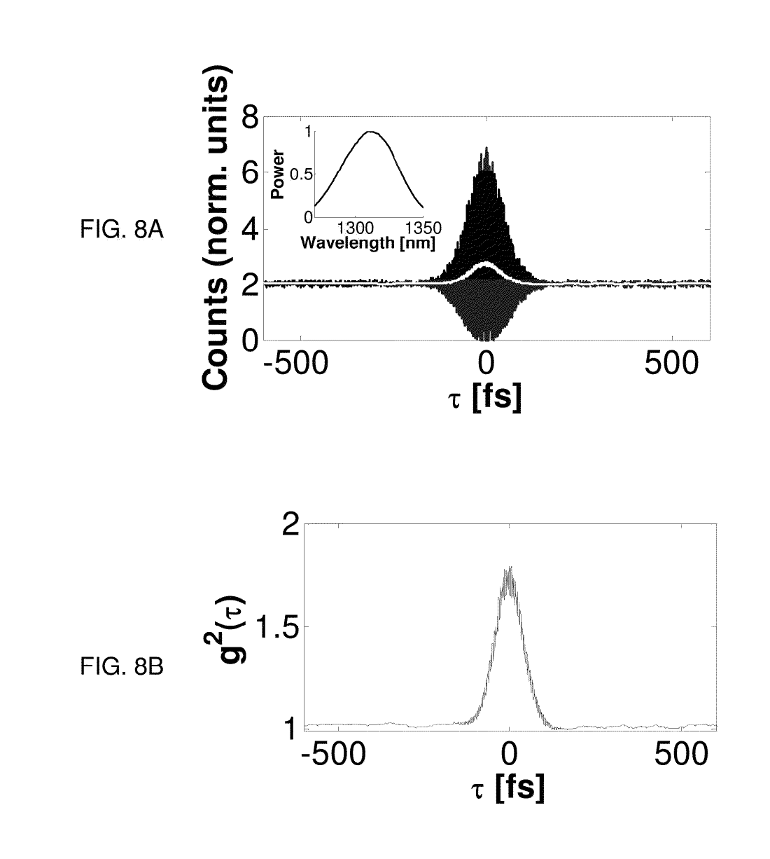

It is noted that other sources such as, but not limited to, superluminescent diodes (SLDs), can also be used, resulting in a slightly reduced amplitude of g⁽²⁾(0) to below 2. Representative results of experiments using SLD are shown in FIGS. 8A-B. FIG. 8A shows an interferogram (black) and average (white) for a 1.3 μm SLD. The inset shows the spectrum of the source. FIG. 8B shows g⁽²⁾(τ) as extracted from the interferogram, demonstrating a reduced bunching, g⁽¹⁾(τ)<g⁽²⁾(0)<2.

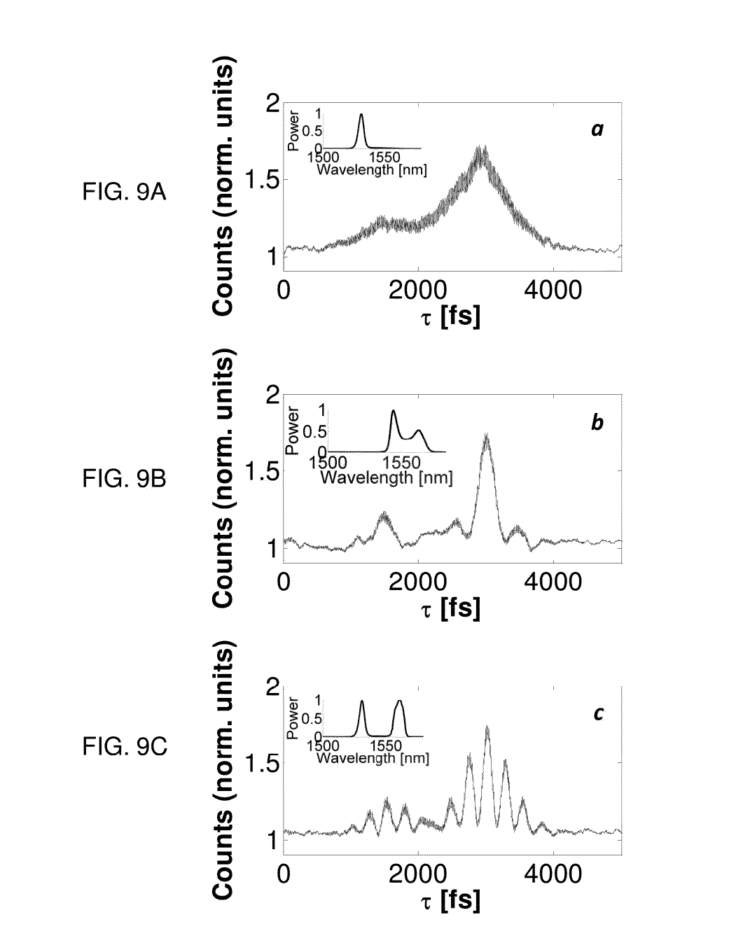

It is also noted that the bandwidth of the chaotic source can be increased by combining several chaotic sources. Imaging of two reflectors at a distance of 150 μm filled with glass is presented in FIGS. 9A-C. FIG. 9A shows result obtained using a single source with a single spectral lobe, FIG. 9B shows result obtained using a single source with two spectral lobes, and FIG. 9C shows result obtained when the two sources were combined after filtering one of the lobes of the second source. The different spectra of the combined sources are presented in each inset.

Another drawback of first-order interference is that the two fields involved must have a common polarization in order to interfere. Therefore, any polarization rotation in one arm of the interferometer with respect to the other arm reduces the visibility of the field-field interference fringes, wherein perpendicular polarizations result in a complete erasure of the signal.

Use of second-order interference according to some embodiments of the present invention, allows having different polarizations at the return and reflected beams, since intensity-intensity interference exists even for perpendicular polarizations, and is almost insensitive to the photons polarization in bulk detectors. Moreover, since polarization changes affect the fringes at ω₀, and 2ω₀ of the second-order interference, the information about the amount of anisotropy of the sample can be extracted from the visibility factor of the measured interferogram.

The matrix element of a two-photon transition is the square of a scalar product between two vector fields. It can therefore be verified that the Fourier contents of the interferogram around ω₀ and around 2ω₀ are respectively multiplied by cosθ and cos²θ, where θ is the angle between the polarization of the fields. The g⁽²⁾(τ) term around DC remains unaffected, as it is the result of a scalar product between the fields in each of the arms with itself.

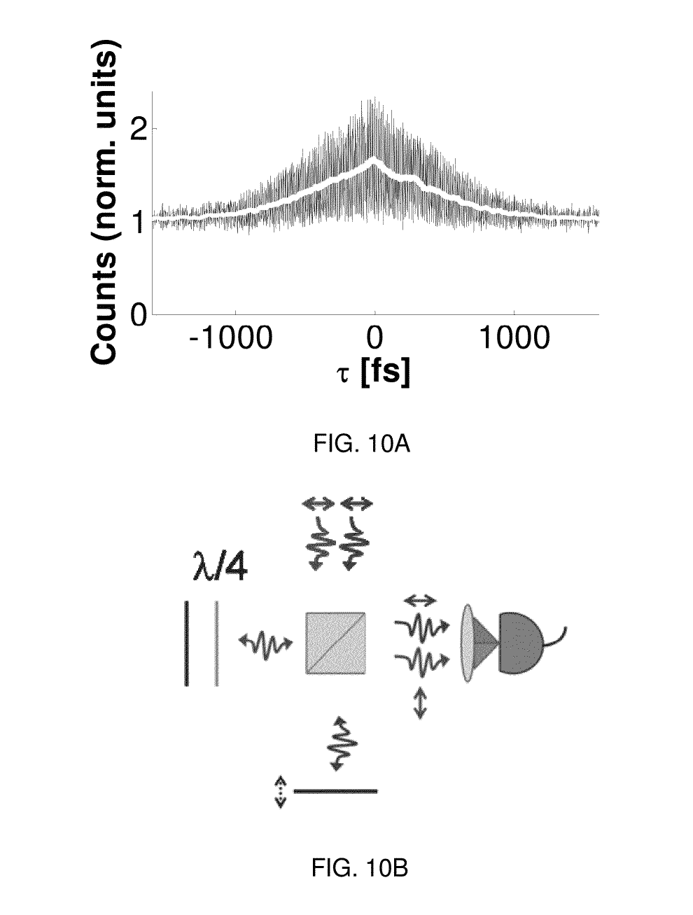

To demonstrate this effect a λ/4 waveplate was inserted into the sample arm of the interferometer, thereby generating nearly orthogonal polarizations and leading to a significant reduction in the fringes' visibility while maintaining the low-frequency term given by EQ. 3. The results of this experiment are shown in FIG. 10A, wherein the interferogram and average are shown in black and white, respectively. As shown, the fringes do not vanish completely because the waveplate does not rotate the entire spectral width of the source. FIG. 10B is a schematic illustration of the setup.

Three of the factors responsible for the limited imaging depth in first-order OCT are absorption, multiple backscattering, and multiple forward scattering. In most biological tissues, the latter two dominate. For simplicity of the following discussion, it is assume that Δτ(x, y, t) in EQ. 2 is not a function of t, so that the temporal integration can be disregarded. This isolates the effect of multiple forward scattering on the depth limit of OCT. Additionally, a refractive index which varies spatially in the medium as a stationary random field is considered. In this case, if the radius of the cross section A of the beam is much larger than the characteristic length of refractive index variations, then the spatial integration in EQ. 2 can be replaced by a mean over realizations,

\tilde{S}⁽¹⁾(τ)= [symbol] S⁽¹⁾(τ−Δτ) [symbol] =∫S⁽¹⁾(τ−η)f_{Δτ}(η)dη,

where f_{Δτ} is the probability density function of Δτ.

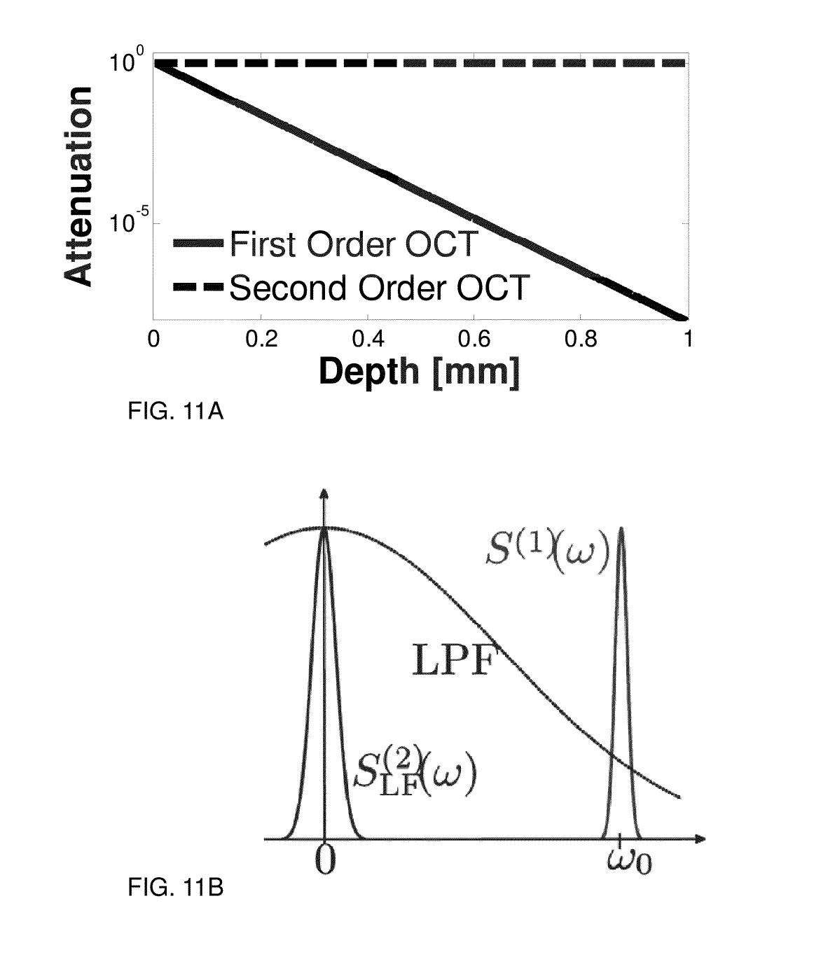

Thus, \tilde{S}⁽¹⁾(τ) is the result of convolving S⁽¹⁾(τ) with f_{Δτ}. As the frequency contents of the former is concentrated around ω₀ and the latter is of low-pass nature, this results in effective attenuation (see FIG. 11B, described below).

Spatial correlations in the refractive index within biological tissues can be described by the Matérn model, with characteristic variation length L₀ on the order of 4-10 μm [J. M. Schmitt, G. Kumar, “Turbulent nature of refractive-index variations in biological tissue,” Opt. Lett. 21, 1310-1312 (1996)]. Assuming that the refractive index fluctuation δn is a Gaussian random field, if a perfect reflector is placed at a distance of L/2 below the surface, then f_{Δτ}(η) is a Gaussian function with mean zero and variance

$$〈 Δ {τ}^{2} 〉 = \frac{2 {L}_{0} 〈 δ {n}^{2} 〉}{c} ( L - {L}_{0} ( 1 - {e}^{- \frac{L}{{L}_{0}}} ) ) ,$$

where [symbol] δη² [symbol] is the fluctuations' variance. In this case, using a chaotic light source with Gaussian broadening in a conventional OCT (first-order), results in an attenuation of the peak of the interferogram's envelope by a factor of

$${α}_{1} = \frac{{τ}_{c}}{{\tilde{τ}}_{c}} exp \{ - \frac{{τ}_{c}^{2} {ω}_{0}^{2} 〈 Δ {τ}^{2 } 〉}{2 {\tilde{τ}}_{c}^{2}} \} \qquad ( 4 )$$

where \tilde{τ}_{c}²=τ_{c}²+π [symbol] Δτ² [symbol] .

For phase shifts on the order of the optical wavelength or larger, the term ω₀² [symbol] Δτ² [symbol] is dominant and the effective attenuation is significant. By contrast, the attenuation factor for the low-frequency (near DC) term of the SO-OCT measurement in the same setting is

$${α}_{2} = \frac{{τ}_{c}}{{τ}_{c} + 2 π 〈 Δ {τ}^{2 } 〉} \qquad ( 5 )$$

The present inventors found that this factor becomes significant only when the phase variations are on the order of the coherence time of the source, which is typically much larger than the optical wavelength. FIG. 11A shows the value of the peak of the interferogram's envelope in first- and second-order OCT for imaging through turbid media, as a function of depth (EQ. 4 and 5), for L₀=4 μm, <δn²>=0.01², and a source of wavelength 1.3 μm and coherence time τ_{c}=100 fs. FIG. 11B visualizes the frequency content of the two modalities along with the frequency response of the Low-Pass Filter (LPF) caused by the phase-variations.

While optical absorption within the tissue limits the penetration depth of any type of optical imaging modality, the absorption length in most tissues is at least an order of magnitude larger than the scattering length. Therefore, reducing the sensitivity to scattering results in significant improvement in imaging depth.

Since the light scattered from biological tissue generates a pattern of speckles [J. M. Schmitt, S. H. Xiang, K. M. Yung, “Speckle in optical coherence tomography,” J. Biomed. Opt. 4, 95-105 (1999)1, much of the phase shifts are within the coherence time, as otherwise the different paths would not have interfered to generate speckle.

It is noted that from a quantum mechanical perspective, the robustness of the technique of the present embodiments is attributed to the indistinguishability between the two paths the photon-pair may take in the interferometer before being absorbed by the two photon absorption mechanism.

The increased signal around a symmetry point results from a constructive interference of two indistinguishable Feynman alternatives for detection: (i) photon 1 passes through the turbulence and reflected from the sample, while photon 2 propagates to the reference minor; and (ii) photon 2 passes through the turbulence, while photon 1 propagate to the reference minor. The phase shifts are canceled in pairs.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification to are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

In the claims:

1. A system for optical coherence tomography (OCT), comprising:
an optical interferometer apparatus configured to split an optical beam into a reference beam directed to a reference reflector and a sample beam directed to a sample, and to combine a reflected beam from said reference reflector with a returning beam from said sample to form a combined optical signal;
a two photon detector configured to detect said combined optical signal by two photon absorption and to provide a corresponding electrical signal;
a frequency separation system configured to separate a low frequency component from said electrical signal; and
a data processor configured for providing a topographic reconstruction of said sample based, at least in part, on said low frequency component.

2. The system according to claim 1, further comprising an optical element positioned at the optical path of said combined optical signal, wherein said detector engages an image plane of said optical element.

3. The system according to claim 1, further comprising a digitizer for digitizing said electrical signal, wherein said frequency separation system comprises a digital low pass filter.

4. The system according to claim 1, wherein said frequency separation system comprises an analog low pass filter.

5. The system according to claim 3, wherein said data processor is configured to analyze a carrier frequency component of said electrical signal, to compare said carrier frequency component with said low frequency component, and to generate an output pertaining to at least one property of said sample other than said topographic reconstruction.

6. The system according to claim 5, wherein said at least one property comprises optical polarizability.

7. The system according to claim 5, wherein said at least one property comprises isotropy or deviation from isotropy.

8. The system according to claim 1, wherein said frequency separation system comprises an optical device positioned in an optical path of said reflected beam and configured for modulating said reflected beam.

9. The system according to claim 8, wherein said optical device comprises a high frequency modulator.

10. The system according to claim 8, wherein said optical device comprises a phase modulator.

11. The system according to claim 1, wherein said reference reflector is mounted on a translation stage characterized by a spatial resolution of at least 20 nm

12. The system according to claim 1, wherein said reference reflector is mounted on a translation stage characterized by a spatial resolution of at least 2 μm.

13. The system according to claim 1, wherein said reference reflector comprises an array of reflectors configured to provide a plurality of spatially separated reflected beams.

14. The system according to claim 1, further comprising:
at least one optical modulator configured to modulate at least one of said reflected beam and said returning beam, and a controller for controlling said modulation,
wherein said data processor is configured to identify noise component in said electrical signal based on said controlled modulation.

15. The system according to claim 1, wherein said data processor is configured to employ time domain topographic reconstruction.

16. The system according to claim 1, wherein said data processor is configured to employ frequency domain topographic reconstruction.

17. The system according to claim 1, wherein said optical interferometer apparatus comprises a non-linear optical medium configured and positioned to combine said reflected beam and said returning beam.

18. A method of optical coherence tomography (OCT), comprising:
splitting an optical beam into a reference beam directed to a reference reflector and a sample beam directed to a sample;
combining a reflected beam from said reference reflector with a returning beam from said sample to form a combined optical signal;
using a detector for detecting contribution of said combined optical signal to two photon absorption in said detector, to provide an electrical signal;
separating a low frequency component from said returning beam or said electrical signal; and
using a data processor for providing a topographic reconstruction of said sample based, at least in part, on said low frequency component.

19. The method according to claim 18, further comprising passing said combined optical signal through at least one optical element configured to form an image plane wherein said detecting is generally at said image plane.

20. The method according to claim 18, wherein said separation is executed by a digital filter.

21. The method according to claim 18, wherein said separation is executed by an analog filter.

22. The method according to claim 20, further comprising:
analyzing a carrier frequency component of said electrical signal;
comparing said carrier frequency component with said low frequency component; and
determining at least one property of said sample other than said topographic reconstruction.

23. The method according to claim 22, wherein said at least one property comprises optical polarizability.

24. The method according to claim 18, wherein said separation comprises modulating said returning beam.

25. The method according to claim 18, wherein said separation comprises vibrating at least one of said sample and said reference beam.

26. The method according to claim 18, further comprising moving said reference reflector at a spatial resolution of at least 20 nm to effect a depth scan in said sample.

27. The method according to claim 18, further comprising moving said reference reflector at a spatial resolution of at least 2 μm to effect a depth scan in said sample.

28. The method according to claim 18, wherein said reference reflector comprises an array of reflectors configured to provide a plurality of spatially separated reflected beams, wherein said combining comprises combining each of at least a portion of said reflected beams with said returning beam to form a plurality of combined optical signals, each corresponding to a different depth in said sample.

29. The method according to claim 18, further comprising modulating at least one of said reflected beam and said returning beam and identifying a noise component in said electrical signal based on said modulation.

30. The method according to claim 18, wherein said topographic reconstruction comprises time domain topographic reconstruction.

31. The method according to claim 18, wherein said topographic reconstruction comprises frequency domain topographic reconstruction.

32. The method according to claim 31, further comprising passing said optical beam through a monochromator and controlling said monochromator so as to dynamically vary a wavelength of said optical beam, wherein said frequency domain topographic reconstruction is responsive to said dynamic variation.

33. The method according to claim 31, further comprising passing said combined optical signal through a monochromator and controlling said monochromator so as to dynamically vary a wavelength of said combined optical signal, wherein said frequency domain topographic reconstruction is responsive to said dynamic variation.
